(19) United States
(12) Patent Application Publication
(10) Pub. No.: US 2026/0243253 A1
(43) Pub. Date: Aug. 20, 2026

(54) PUMP STATOR TIE-LAYER WITH SURFACE ROUGHNESS

(71) Applicant: SCHLUMBERGER TECHNOLOGY CORPORATION, Sugar Land, TX (US)

(72) Inventors: Peter HONDRED, Lawrence, KS (US); Jason HOLZMUELLER, Lawrence, KS (US); Maxim PUSHKAREV, Lawrence, KS (US); William GOERTZEN, Lawrence, KS (US)

(21) Appl. No.: 19/136,949

(22) PCT Filed: Dec. 21, 2023
(86) PCT No.: PCT/US2023/085287

§ 371 Date: Jun. 9, 2025

Related U.S. Application Data
(60) Provisional application No. 63/434,643, filed on Dec. 22, 2022.

(51) Int. Cl. F04C 2/107; E21B 43/12

(52) U.S. Cl. CPC F04C 2/1071; E21B 43/121

(57) ABSTRACT

A fluid displacement pump can include a rotor; and a stator, where the stator includes two materials bonded by a tie-layer material and where the tie-layer is formed with surface roughness. A method can include forming surface roughness in tie-layer of a stator; depositing material on the tie-layer; and forming a stator, where the stator includes two materials bonded by the tie-layer material.

### CROSS REFERENCE TO RELATED APPLICATIONS

This application claims the benefit of U.S. Provisional Patent Application No. 63/434,643 filed Dec. 22, 2022, the entire contents of which are hereby incorporated in their entirety.

### BACKGROUND

In many well applications, electric submersible pumps (ESPs) are deployed downhole to provide artificial lift for lifting oil to a collection location. An ESP has a series of centrifugal pump stages contained within a protective housing and mated to a submersible electric motor. The ESP may be installed at the end of a production string and is powered and controlled via an armor protected cable. Electric submersible pumps may be used in a variety of moderate-to-high-production rate wells, however each ESP is designed for a specific well and for a relatively tight range of pumping rates.

As the well pressure and volume taper off, the ESP can begin to operate outside of the specified range. This results in substantial reductions in system efficiencies and can lead to major mechanical problems, excessive energy costs, and premature pumping system failure. When the efficiency of the pump has been reduced, an operator may transition to a low flow solution such as a sucker rod pump or similar system which can accommodate the lower production volumes. However, such low flow systems have relatively limited applications and often cannot be deployed in unconventional deviated wells, e.g., horizontal wells.

### SUMMARY

A fluid displacement pump can include a rotor; and a stator, where the stator includes two materials bonded by a tie-layer material and where the tie-layer is formed with surface roughness. A method can include forming surface roughness in tie-layer of a stator; depositing material on the tie-layer; and forming a stator, where the stator includes two materials bonded by the tie-layer material.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a schematic illustration of an example of an electric submersible progressive cavity pumping system having a progressive cavity pump and being deployed downhole in a borehole, e.g., a wellbore, according to an embodiment of the disclosure;

FIG. 2 is a cross-sectional view of an example of a progressive cavity pump, according to an embodiment of the disclosure;

FIG. 3 is an orthogonal view of an example of a progressive cavity pump composite stator for use with an electric submersible progressive cavity pump, the composite stator illustration being partially broken away to show examples of composite layers, according to an embodiment of the disclosure;

FIG. 4 is an end view of an example of a composite stator, according to an embodiment of the disclosure;

FIG. 5 is an orthogonal view, partially broken away, of an example of a progressive cavity pump composite stator combined with a rotor to form an electric submersible progressive cavity pump, according to an embodiment of the disclosure;

FIG. 6 is a series of diagrams of examples of pumps;

FIG. 7 is an example of a plot;

FIG. 8 is a photograph of an example of a failed stator;

FIG. 9 is a series of diagrams of examples of pump components;

FIG. 10 is a series of diagrams of examples of pump operations;

FIG. 11 is a series of diagrams of examples of pump components;

FIG. 12 is a diagram of an example of pump components;

FIG. 13 is a diagram of an example of a chemical formula;

FIG. 14 is a diagram of an example of a method;

FIG. 15 is a series of diagrams of examples of extrusion equipment and processes;

FIG. 16 is a series of diagrams of examples of surface roughness;

FIG. 17 is a diagram of an example of a method; and

FIG. 18 is a diagram of computing devices.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The disclosure herein generally involves a system and methodology for facilitating efficient well production in relatively low volume applications, e.g., applications after well pressure and volume taper off for a given well. According to an embodiment, use of an electric submersible progressive cavity pump is enabled in harsh, high temperature downhole environments. In some applications, an ESP system may initially be used to pump fluid, e.g., oil, from the well while the volume of flow is moderate to high. However, after the volume of flow tapers off and the ESP efficiency drops a sufficient degree, the ESP system is then removed and replaced by the electric submersible progressive cavity pump. Substitution of the electric submersible progressive cavity pump provides a seamless way for continuing efficient production. As explained in greater detail below, the electric submersible progressive cavity pump is constructed for long-term use even in the high temperature, harsh downhole environment.

Long-term, efficient use of the progressive cavity pump in harsh downhole environments is facilitated with a composite pump stator. The composite stator can include an outer housing and a thermoset resin layer located within the outer housing and secured to the outer housing. The thermoset resin layer is constructed with an internal surface having an internal thread design, e.g., a helical thread design. Additionally, an elastomeric layer is located within (e.g., radially within and/or on or adjacent an inner surface of) the thermoset resin layer and has a shape which follows the internal thread. In this manner, the elastomeric layer is able to provide an interior surface generally matching the shape of the internal thread of the thermoset resin layer. The arrangement of the layers and the materials selected for the layers provide a composite stator structure which has great longevity in harsh, high temperature downhole environments while providing an appropriate surface for creating pumping cavities along which fluid is pumped when an internal rotor is rotated relative to the composite pump stator. The inner elastomer layer may be initially formed as an extruded tube which is then inserted into an interior of the intermediate thermoset layer. The extruded tube conforms to the thread pattern and provides an enhanced surface interface with the rotor.

According to an embodiment, the electric submersible progressive cavity pump system combines a progressive cavity pump with a motor and a gearbox which are all submersible and may be fully submersed downhole. This allows the electric submersible progressive cavity pump system to be constructed as a drop-in replacement for an ESP and to utilize the same surface equipment. As a result, continued production can be maintained on a cost effective basis. Additionally, use of a progressive cavity pump enables use of the overall electric submersible progressive cavity pump system in a wide variety of wells including unconventional deviated wells, e.g., horizontal wells.

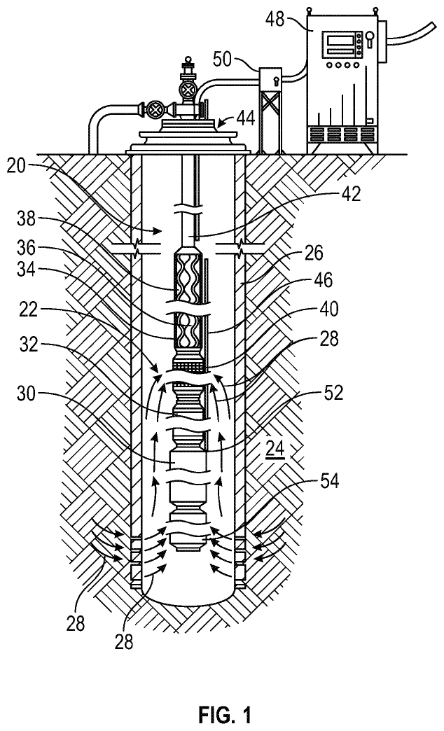

Referring generally to FIG. 1, an example of an electric submersible progressive cavity pump system 20 is illustrated as deployed in a borehole 22, e.g., a wellbore. In this embodiment, the wellbore 22 is drilled into a subterranean formation 24 and, in some applications, may be lined with casing 26. Perforations are formed through the casing 26 and out into the surrounding formation 24 to enable the inflow of oil 28 and/or other fluids which may then be pumped to a collection location via the electric submersible progressive cavity pump system 20.

According to the example illustrated, the electric submersible progressive cavity pump system 20 may comprise a submersible motor 30, e.g., an induction motor or a PMM (permanent magnet motor), a submersible gearbox 32 driven by the motor 30, and a progressive cavity pump 34 driven via the gearbox 32. The progressive cavity pump 34 may comprise a rotor 36 rotatably positioned within a surrounding composite stator 38. The motor 30 and gearbox 32 may be used to drive/rotate the rotor 36 within the composite stator 38 to pump fluid, e.g., oil 28. For example, the oil 28 entering wellbore 22 may be drawn in through a pump intake 40 and pumped via progressive cavity pump 34 up through a tubing 42, e.g., a production tubing. From tubing 42, the pumped fluid may be directed through a wellhead 44 to an appropriate surface collection location.

Electric power may be provided downhole to the submersible motor 30 via a power cable 46. In the example illustrated, the power cable 46 is routed along the tubing 42 and connected with a power source 48, e.g., a variable speed drive or switchboard, via a cable junction box 50. However, appropriate electrical power may be provided to the downhole motor 30 via various types of power supply systems. The power cable 46 is connected to the motor 30 by a sealed motor electrical connector 52.

Depending on the parameters of a given application, the electric submersible progressive cavity pump system 20 may comprise a variety of other components and/or may be coupled with a variety of other components and systems. By way of example, various shaft seals, motor protectors, and other components may be connected with, or integrated into, the motor 30 and/or gearbox 32. In the illustrated example, a lower component 54 is coupled with motor 30 on a downhole side of the motor 30. By way of example, the lower component 54 may be an oil compensator or a base gauge. However, many other types of components and systems may be connected with or used in combination with the electric submersible progressive cavity pump system 20.

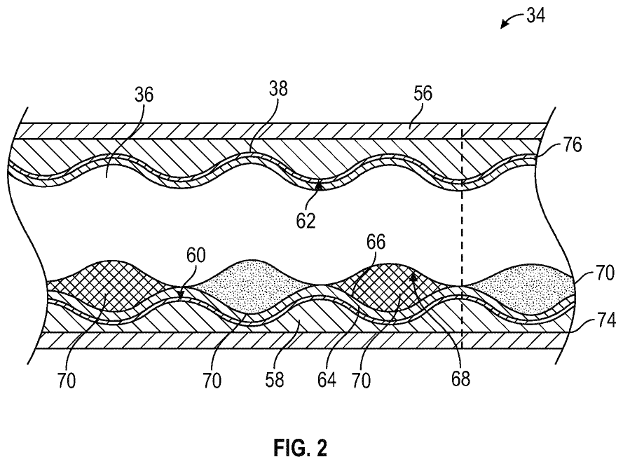

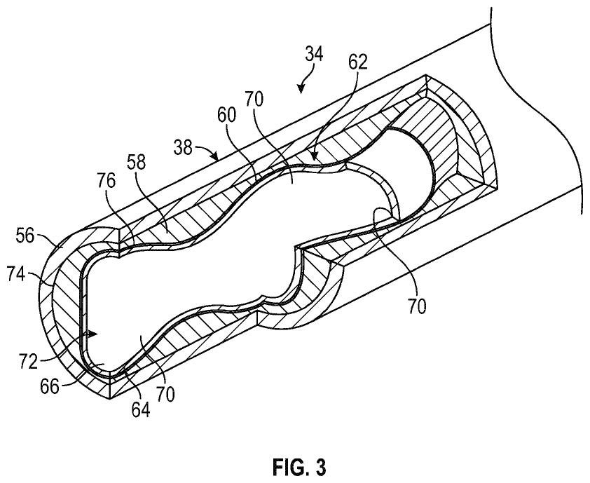

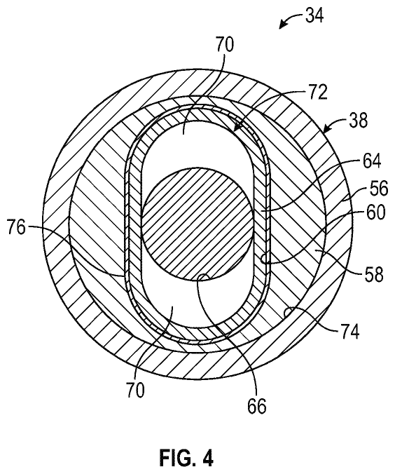

With additional reference to FIG. 2, an embodiment of the composite stator 38 of progressive cavity pump 34 comprises an outer housing 56, e.g., a metal outer housing, and a first layer 58 located within (e.g., radially within) the outer housing 56. The first layer 58 may be formed from a thermoset resin and may be secured to the outer housing 56 along an interior surface of the outer housing 56. The first layer 58 is molded or otherwise constructed to have an interior surface 60 formed as an internal thread 62. For example, the internal thread 62 may be formed as a helical thread (see also FIGS. 3 and 4).

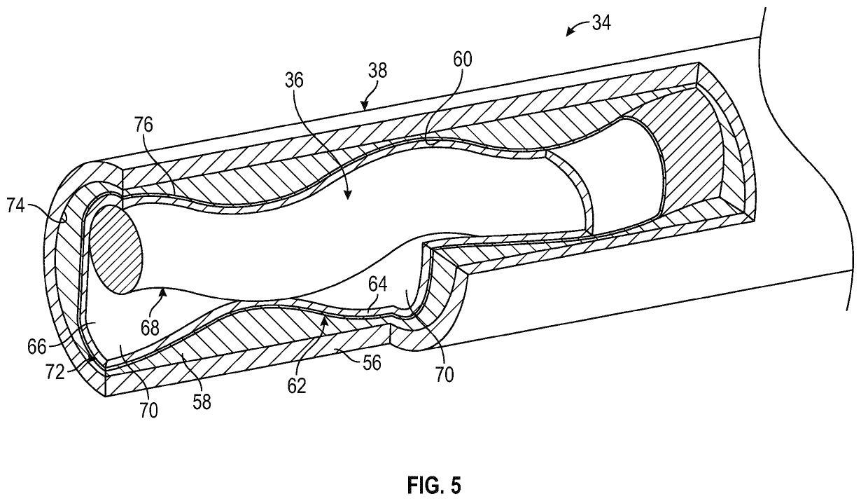

The illustrated composite stator 38 further comprises a second layer 64 located within (e.g., radially within and/or on or adjacent an inner surface of) first layer 58. The second layer 64 can be secured to the first layer 58 along the internal thread 62. The second layer 64 may be formed from an elastomer in a shape which follows the internal thread 62 such that a second layer interior surface 66 generally matches the shape of the first layer interior surface 60. In other words, the interior surface 66 of second layer 64 also presents an internal thread construction, e.g., a helical internal thread, which provides an operational interface with rotor 36. The thread configuration of interior surface 66 and a corresponding thread shaped exterior 68 of rotor 36 (see also FIG. 5) are constructed to create progressing cavities 70 along composite stator 38 as rotor 36 is rotated relative to composite stator 38. As with conventional progressive cavity pumps, rotation of rotor 36 causes these progressing stator cavities 70 to move fluid, e.g., oil 28, along the composite stator 38 until discharged, e.g., discharged into tubing 42. Thus, the elastomer layer 64 is the primary stator elastomer against which the rotor 36 rotates.

Referring again to FIGS. 3 and 4, the various layers of composite stator 38 may be constructed from various types of materials, as described in greater detail below. However, the layer materials as well as the materials/mechanisms for securing the multiple layers together are selected to enable operation at high temperatures and in aggressive fluid environments for long durations. As a result, the composite stator 38 enables long-term operation of the electric submersible progressive cavity pump system 20 in downhole environments.

In the example illustrated in FIGS. 3 and 4, the outer housing/layer 56 may be constructed from metal or other suitable material able to withstand downhole conditions. By way of example, the outer housing 56 may be constructed from various carbon steels or stainless steels. However, the outer housing 56 also may be constructed from materials such as ni-resist, nickel alloys, or other suitable materials.

With respect to the first layer 58, this layer may be constructed from a thermoset resin which may be formulated in various thermoset composites. For example, the first layer 58 may be a structural thermoset resin having a glass transition temperature greater than a desired final application temperature. Additionally, the structural thermoset resin should be capable of bonding completely with a bonding layer as discussed in greater detail below. The thermoset resin layer 58 may be constructed, e.g., molded, from a thermosetting epoxy base system having a high glass transition temperature (Tg) and good resistance to downhole conditions. One example is a thermosetting epoxy comprising CoolTherm EL-636 resin available from Parker LORD.

However, various types of epoxies may be formed from a variety of thermoset resins for use in constructing the first layer 58 and the internal thread shape. Examples of such thermoset resins and suitable materials for first layer 58 include bismaleimide, cyanate esters, preceramic thermosets, phenolics, novalacs, dicyclopentadiene-type systems, or other thermoset materials with sufficient Tg and bonding capability.

To further improve performance of the first layer 58 in various harsh operating conditions, various additives may be combined into the thermoset resin. For example, fillers may be incorporated into the thermoset resin to improve heat dissipation and to reduce the coefficient of thermal expansion (CTE). Examples of suitable fillers include mineral particles, metal powder, ceramic or organic particles, silica, alumina fillers, aluminum metal particles, or other suitable metal particles. Additionally, adhesion promoting additives may be combined into the thermoset resin layer 58 to enhance bonding to adjacent layers. In some embodiments, rubberized additives may be added to the thermoset resin layer 58 to increase toughness/fracture resistance. This could involve blending a certain amount of elastomer into the thermoset material. Various other additives may be combined to, for example, promote compatibility with the adjacent elastomer layer 64.

In the example illustrated in FIGS. 3 and 4, the second layer 64 is an elastomer layer formed as an extruded tube 72. The extruded tube 72 is inserted or positioned along the interior of the first layer 58 and is sufficiently pliable to conform to the shape of internal thread 62 so as to present its interior surface 66 in a corresponding thread pattern, e.g., a helical thread pattern. By way of example, the second layer 64 may be formed with a generally constant wall thickness. [0028] The extruded tube 72 or other types of second layer 64 may be formed from a variety of elastomers, e.g., rubbers, able to provide the desired contact and interaction with the rotor 36. The materials selected to form elastomer layer 64 also are resistant to downhole conditions, e.g., resistant to well fluids and downhole temperatures. Specific compounds may be optimized for good dynamic properties, low hysteresis, and high tensile and tear strength.

By forming the second layer 64 as an extruded tube 72, much higher viscosities can be tolerated. As a result, elastomer materials having much higher strength may be selected so as to provide a substantially greater resistance to damage. Examples of suitable elastomer materials for construction of second layer 64/extruded tube 72 include nitrile rubber (NBR), hydrogenated nitrile rubber (HNBR), and FKM fluoroelastomer, e.g., VITON™ available from The Chemours Company or Fluorel™ available from Dyneon LLC. For very high heat applications, e.g., greater than 180° C., the second layer 64/extruded tube 72 may be constructed from materials such as tetrafluoroethylene propylene (e.g., FEPM) or VITON™ Extreme™ fluoroelastomer products available from The Chemours Company.

For example as shown in the example illustrated in FIGS. 3 and 4, the composite stator 38 may further comprise a bonding layer 74 located between the outer housing 56 and the first layer 58 and/or a middle bonding layer 76 located between the first layer 58 and the second layer 64. The bonding layer 74 may comprise a variety of materials and/or structures which are able to secure the thermoset resin of first layer 58 to the surrounding housing 56, e.g., metal housing. By way of example, the bonding layer 74 may comprise various adhesives which remain functional in the hot, harsh downhole environment. However, the bonding layer 74 also may comprise physical elements and may be formed with a molded fit, a press fit, or another type of friction fit between the first layer 58 and the surrounding outer housing 56.

With respect to bonding layer 76, this bonding layer may similarly use a variety of materials. According to an embodiment, the bonding layer 76 comprises an elastomer compound which may use the same base polymer as the elastomer of second layer 64 or other suitable variants. For example, if the elastomer layer 64 is formed from nitrile rubber with 40% acrylonitrile (ACN), the bonding layer 76 may use a similar material but with 30% ACN. However, the bonding layer 76 also can be formulated with a different type of elastomer that is at least partially compatible, e.g., forming bonding layer 76 with ethylene propylene diene monomer (EPDM) while the primary elastomer of second layer 64 is formed with hydrogenated nitrile rubber (HNBR).

In a variety of applications, the bonding layer 76 is formulated with an elastomer material capable of coextrusion and co-crosslinking with the elastomer of elastomer layer 64. Accordingly, both the bonding layer 76 and the elastomer layer 64 may be capable of using the same type of cross-linking system, although the bulk of each elastomer may use different curing systems. To facilitate longevity downhole in certain applications, the formulation of bonding layer 76 may be optimized for bonding instead of, for example, dynamic loading and high tensile strength.

Accordingly, embodiments of bonding layer 76 may utilize components and techniques known to facilitate bonding between the thermoset resin layer 58 and the elastomer layer 64. Examples of such components/techniques include using hot polymerized nitrile rubber and/or use of fillers that promote bonding, e.g., fumed and precipitated silica, diatomaceous earth, or other mineral fillers. Additional examples include the use of metal oxides that promote bonding. Such metal oxides tend to be elastomer dependent but may include zinc oxide, aluminum oxide, lead oxides, calcium oxides, magnesium oxides, iron oxides, and other suitable metal oxides.

Additional components and techniques which facilitate bonding include the use of a base polymer in bonding layer 76 with increased unsaturation (higher residual double bond content). Adhesion promoting additive polymers with high unsaturation, e.g., RICON™ 154 90% vinyl polybutadiene, also may be used in formulating bonding layer 76. There also are many multifunctional additives which promote adhesion and include, for example, maleated polybutadiene, methacrylated polybutadiene, epoxidized polybutadiene, acrylated bonding coagents, and various monomer oligomers or polymers having functionality allowing the bonding layer 76 to interact with two different systems presented by the elastomer of layer 64 and the thermoset material of layer 58.

Furthermore, the bonding layer 76 may utilize catalysts, curative agents, or reactive agents which enhance reactivity and bonding with the thermoset composite layer. The bonding layer 76 also may be formulated with various additives or according to manufacturing processes which create increased surface area to further enhance bonding with the adjacent layers, e.g., thermoset layer 58. An example of a manufacturing process which facilitates bonding is extruding the bonding layer 76 with a rough or porous surface. Depending on the material composition of both the elastomer layer 64 and the thermoset layer 58, the material of bonding layer 76 may be selected according to its ability to chemically bond with both layers 58, 64.

By using a thermoset material to form the first layer 58 with internal thread 62/stator cavities 70 and then inserting a second elastomer layer 64, the composite stator 38 is relatively inexpensive to construct. As described above, the construction of elastomer layer 64, e.g., extrusion of elastomer layer 64 as tube 72, in combination with selecting suitable layer materials described herein and bonding elastomer layer 64 to the first layer 58 via bonding layer 76 provides a composite stator 38 which has a high resistance to temperature and well fluid. This allows use of the composite stator 38 over long periods of time in a variety of downhole applications.

The securely bonded elastomer layer 64 also presents a rugged, long-lasting interior surface 66 for long-term interaction with rotor 36, as illustrated in FIG. 5. Once the rotor 36 is inserted into the composite stator 38 and the overall electric submersible progressive cavity pump system 20 is assembled, the pump system 20 may be deployed downhole into a variety of wellbores 22, including many types of deviated, e.g., horizontal, wellbores for production of oil 28 or other downhole fluids. The electric submersible progressive cavity pumping system 20 may initially be employed as the primary artificial lift system. In a variety of applications, however, a conventional ESP system may initially be employed to pump oil and/or other downhole fluids until well pressure and production rate taper off sufficiently to render the conventional ESP system undesirably inefficient. At that time, the conventional ESP system may be removed and replaced with the electric submersible progressive cavity pump system 20 for efficient well production at a lower flowrate.

The composite structure of stator 38 may be adjusted according to parameters of a given downhole environment and/or pumping application. Additionally, the progressive cavity pump 34 may be constructed in a variety of sizes and configurations. Many types of additional or other components may be incorporated into the overall electric submersible progressive cavity pump system 20 for use in various types and sizes of boreholes, e.g., wellbores.

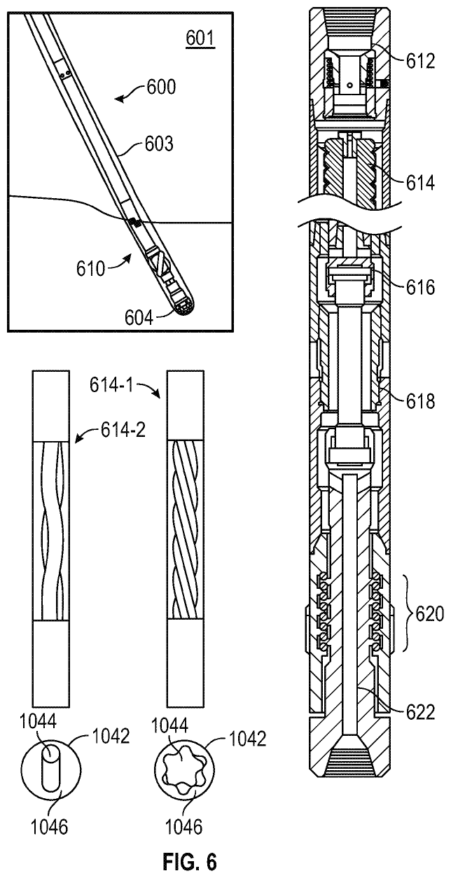

FIG. 6 shows an example of a drilling assembly 600 in a geologic environment 601 that includes a borehole 603 where the drilling assembly 600 (e.g., a drillstring) includes a bit 604 and a motor section 610 where the motor section 610 can drive the bit 604 (e.g., cause the bit 604 to rotate and deepen the borehole 603).

As shown, the motor section 600 includes a dump valve 612, a power section 614, a surface-adjustable bent housing 616, a transmission assembly 618, a bearing section 620 and a drive shaft 622, which can be operatively coupled to a bit such as the bit 604.

As to the power section 614, two examples are illustrated as a power section 614-1 and a power section 614-2 each of which includes a housing 642, a rotor 644 and a stator 646. The rotor 644 and the stator 646 can be characterized by a ratio. For example, the power section 614-1 can be a 5:6 ratio and the power section 614-2 can be a 1:2 ratio, which, as seen in cross-sectional views, can involve lobes (e.g., a rotor/stator lobe configuration). The motor section 610 of FIG. 6 may be a POWERPAK family motor section (Schlumberger Limited, Houston, Texas) or another type of motor section. The POWERPAK family of motor sections can include ratios of 1:2, 2:3, 3:4, 4:5, 5:6 and 7:8 with corresponding lobe configurations.

A power section can convert hydraulic energy from drilling fluid into mechanical power to turn a bit. For example, consider the reverse application of the Moineau pump principle. During operation, drilling fluid can be pumped into a power section at a pressure that causes the rotor to rotate within the stator where the rotational force is transmitted through a transmission shaft and drive shaft to a bit.

A motor section may be manufactured in part of corrosion-resistant stainless steel where a thin layer of chrome plating may be present to reduce friction and abrasion. As an example, tungsten carbide may be utilized to coat a rotor, for example, to reduce abrasion wear and corrosion damage. As to a stator, it can be formed of a steel tube, which may be a housing (see, e.g., the housing 642) with an elastomeric material that lines the bore of the steel tube to define a stator. An elastomeric material may be referred to as a liner or, when assembled with the tube or housing, may be referred to as a stator. As an example, an elastomeric material may be molded into the bore of a tube. An elastomeric material can be formulated to resist abrasion and hydrocarbon induced deterioration. Various types of elastomeric materials may be utilized in a power section and some may be proprietary. Properties of an elastomeric material can be tailored for particular types of operations, which may consider factors such as temperature, speed, rotor type, type of drilling fluid, etc. Rotors and stators can be characterized by helical profiles, for example, by spirals and/or lobes. A rotor can have one less fewer spiral or lobe than a stator (see, e.g., the cross-sectional views in FIG. 6).

During operation, the rotor and stator can form a continuous seal at their contact points along a straight line, which produces a number of independent cavities. As fluid is forced through these progressive cavities, it causes the rotor to rotate inside the stator. The movement of the rotor inside the stator is referred to as nutation. For each nutation cycle, the rotor rotates by a distance of one lobe width. The rotor nutates each lobe in the stator to complete one revolution of the bit box. For example, a motor section with a 7:8 rotor/stator lobe configuration and a speed of 100 RPM at the bit box will have a nutation speed of 700 cycles per minute. Generally, torque output increases with the number of lobes, which corresponds to a slower speed. Torque also depends on the number of stages where a stage is a complete spiral of a stator helix. Power is defined as speed times torque; however, a greater number of lobes in a motor does not necessarily mean that the motor produces more power. Motors with more lobes tend to be less efficient because the seal area between the rotor and the stator increases with the number of lobes.

The difference between the size of a rotor mean diameter (e.g., valley to lobe peak measurement) and the stator minor diameter (lobe peak to lobe peak) is defined as the rotor/stator interference fit. Various motors are assembled with a rotor sized to be larger than a stator internal bore under planned downhole conditions, which can produce a strong positive interference seal that is referred to as a positive fit. Where higher downhole temperatures are expected, a positive fit can be reduced during motor assembly to allow for swelling of an elastomeric material that forms the stator (e.g., stator liner). Mud weight and vertical depth can be considered as they can influence the hydrostatic pressure on the stator liner. A computational framework such as, for example, the POWERFIT framework (Schlumberger Limited, Houston, Texas), may be utilized to calculate a desired interference fit.

As to some examples of elastomeric materials, consider nitrile rubber, which tends to be rated to approximately 138 C (280 F), and highly saturated nitrile, which may be formulated to resist chemical attack and be rated to approximately 177 C (350 F).

The spiral stage length of a stator is defined as the axial length for one lobe in the stator to rotate 360 degrees along its helical path around the body of the stator. The stage length of a rotor differs from that of a stator as a rotor has a shorter stage length than its corresponding stator. More stages can increase the number of fluid cavities in a power section, which can result in a greater total pressure drop. Under the same differential pressure conditions, the power section with more stages tends to maintain speed better as there tends to be less pressure drop per stage and hence less leakage.

Drilling fluid temperature, which may be referred to as mud temperature or mud fluid temperature, can be a factor in determining an amount of interference in assembling a stator and a rotor of a power section. As to interference, greater interference can result in a stator experiencing higher shearing stresses, which can cause fatigue damage. Fatigue can lead to premature chunking failure of a stator liner. As an example, chlorides or other such halides may cause damage to a power section. For example, such halides may damage a rotor through corrosion where a rough edged rotor can cut into a stator liner (e.g., cutting the top off an elastomeric liner). Such cuts can reduce effectiveness of a rotor/stator seal and may cause a motor to stall (e.g., chunking the stator) at a low differential pressure. For oil-based mud (OBM) with supersaturated water phases and for salt muds, a coated rotor can be beneficial.

As to differential pressure, it is defined as the difference between the on-bottom and off-bottom drilling pressure, which is generated by the rotor/stator section (power section) of a motor. As mentioned, for a larger pressure difference, there tends to be higher torque output and lower shaft speed. A motor that is run with differential pressures greater than recommended can be more prone to premature chunking. Such chunking may follow a spiral path or be uniform through the stator liner. A life of a power section can depend on factors that can lead to chunking (e.g., damage to a stator), which may depend on characteristics of a rotor (e.g., surface characteristics, etc.).

As to trajectory of a wellbore to be drilled, it can be defined in part by one or more dogleg severities (DLSs). Rotating a motor in high DLS interval of a well can increase risk of damage to a stator. For example, the geometry of a wellbore can cause a motor section to bend and flex. A power section stator can be relatively more flexible that other parts of a motor. Where the stator housing bends, the elastomeric liner can be biased or pushed upon by the housing, which can result in force being applied by the elastomeric liner to the rotor. Such force can lead to excessive compression on the stator lobes and cause chunking.

A motor can have a power curve. A test can be performed using a dynamo meter in a laboratory, for example, using water at room temperature to determine a relationship between input, which is flow rate and differential pressure, to power output, in the form of RPM and torque. Such information can be available in a motor handbook. However, what is actually happening downhole can be differ due to various factors. For example, due to effect of downhole pressure and temperature, output can be reduced (e.g., the motor power output). Such a reduction may lead one to conclude that a motor is not performing. In response, a driller may keep pushing such that the pressure becomes too high, which can damage elastomeric material due to stalling (e.g., damage a stator).

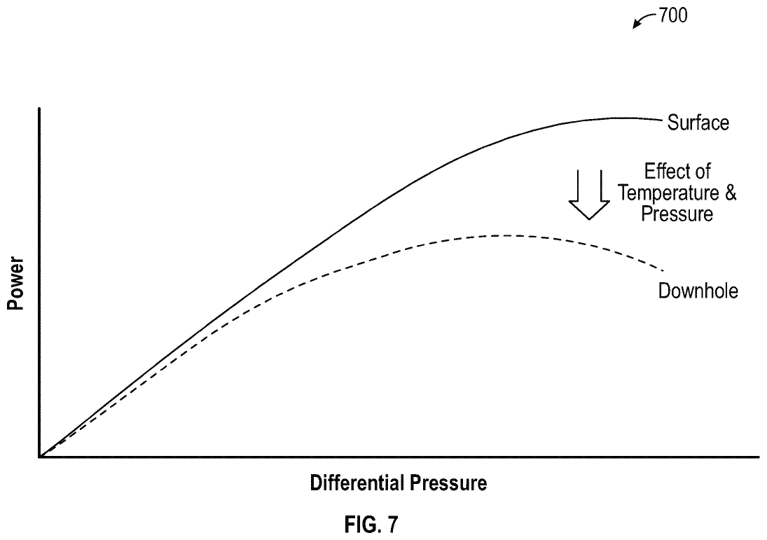

FIG. 7 shows an example of a plot 700 of power versus differential pressure for surface and downhole conditions. As shown, power can be reduced downhole due to effects of temperature and pressure and/or one or more other factors. The plot 700 shows power versus differential pressure where differences between surface and downhole may increase with higher differential pressures.

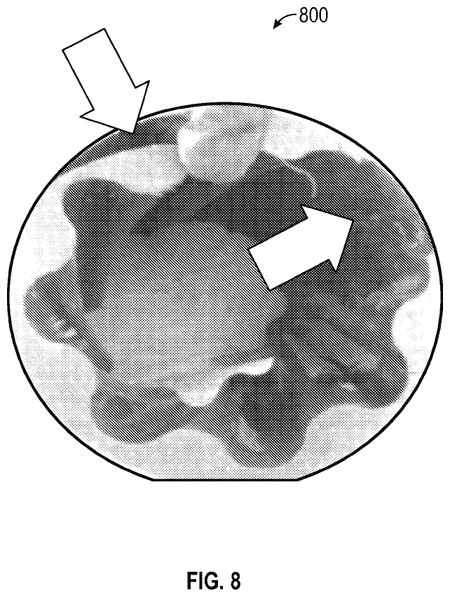

FIG. 8 shows an example of a photograph 800 that illustrates fatigue failure as to an elastomeric material of a stator of a motor. Arrows indicate where separation from a tube or housing has occurred and where chunking has occurred.

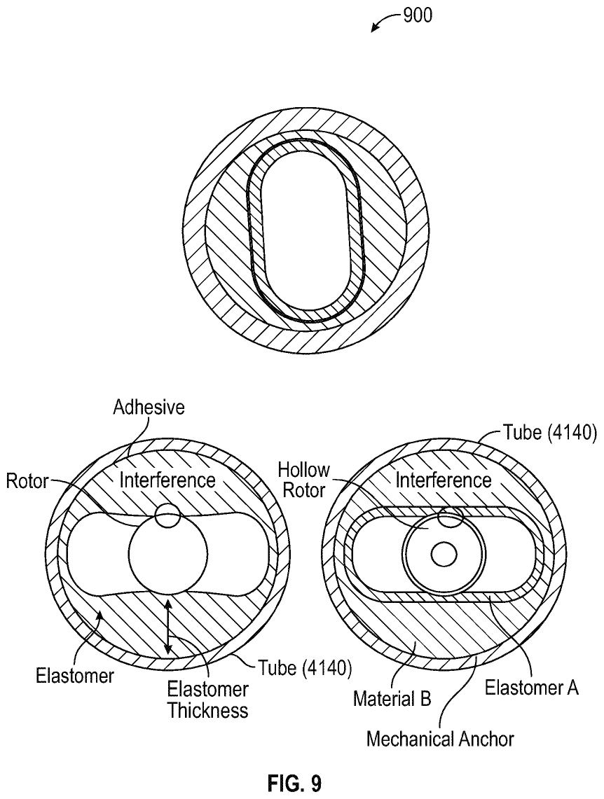

FIG. 9 shows examples of PCP components, including synthetic and/or natural materials, which can include polymeric materials, metals, composite materials, etc.

As an example, in various pumps, construction may use one or more compatabilizing layers, which may provide for enhanced adhesion and/or one or more other benefits.

As explained, ESPs are versatile and adaptable for use in various applications (e.g., artificial lift, injection, etc.). As explained, an ESP can include a series of centrifugal pump stages contained within a protective housing mated to a submersible electric motor. It is installed at the end of the production tubing; an armor-protected cable connects the pump to electric power and surface controls.

By controlling motor speed from surface, operators can vary production flow rate, for example, from 16 to 4,770 m3/d [100 to 30,000 bbl/d]. An ESP tends to be appropriate for moderate-to-high-production rate wells, including highly deviated wells and remote, subsea deep-water wells. As production rates fall, the pump motor can be slowed to accommodate, without an expensive well intervention.

While ESPs can be used for a wide range of flow rates, each specific system may be designed for a specific well; namely a tight range of pumping rates. As the well pressure and volume taper off, the pump begins to operate outside the specified range for the ESP originally installed. This can result in reductions in system efficiencies which can lead to mechanical problems, excessive energy costs, and premature system failure. When the efficiency of the pump has been reduced, inevitably, the operator will transition to a low flow solution such as a sucker rod pump or similar system which can accommodate the lower production volumes. However, these are often limited in effectiveness now that many ESPs are deployed in unconventional deviated wells many of which are even horizontal wells. Consequently, operators are often left without effective means of production alternatives and rely on cost intensive solutions which accelerate the aging of the equipment such as cycling the ESP on and off.

A complementary option to the ESP is an electrical submersible progressive cavity pump (ESPCP). When ESP efficiency drops off, migrating to an ESPCP may be a relatively seamless way to continue efficient production. An ESPCP may be a fully submersible pumping system. While various types of PCP may utilize a motor and gearbox to remain at the surface and the rotor to be driven from the surface by attaching to a long shaft, the ESPCP has a motor and gearbox attached to the pump fully submersed in the well and driven by an electrical power cord. As such, an ESPCP can be a drop-in replacement for the ESP and may utilize the same surface equipment. This reduces the work over cost as well as providing an effective alternative for unconventional deviated and horizontal wells.

As explained, in various types of pumps, one or more stator components may be sources of issues. As an example, a stator may be an injectable elastomer that the rotor moves against. Over time, the elastomer may degrade and/or swell from exposure to the downhole environment. In some instances, for PCP applications, stator deterioration is managed by swapping rotors at the surface. However, with an ESPCP fully submerged, the stator must survive the harsh conditions for generally a longer time than PCP stators can manage in order to make a system a more viable alternative for the low flow unconventional applications.

In various examples of system, such as one or more of those mentioned above, a technique and materials can be employed for bonding of elastomer to a rigid support structure which in the case of the composite PCP may be a thermoset material. Various PCPs utilize one or more of various types of solvent based adhesives such as MEGUM, CHEMLOK, or THIXON to bond the elastomer to the housing. These types of adhesives use highly reactive functional groups to promote interaction between the desired layers to be bonded. However, the reactive functionality that gives theses adhesives strong initial bonding also may predispose them to degradation in a hot/wet downhole environment. The reactive chemistries frequently utilized in solvent based adhesives include isocyanates, phenol/formaldehyde systems, cyanoacrylates, acrylated molecules, chlorinated polymers, and other reactive, typically polar materials that may generate strong adhesive bonds but are subject to hydrolytic degradation and thermal breakdown over time in the downhole environment. When compared to the fluid resistance and thermal stability of typical stator elastomer and structural thermoset elements, the adhesive material very quickly and obviously becomes the limiting factor. By utilizing a compatabilizing elastomer based tie-layer, a more robust bonding of the elastomer and thermoset can be generated through covalent bonding of each material; chemically crosslinking the elastomer to a thermoset. As such the limiting factor to the bond may be transferred to mechanical and chemical stability of the elastomer or thermoset and no longer a third material susceptible to adhesive failure from aging.

As mentioned, a method can use of a compatabilizing elastomer based adhesion promotor that facilitates covalent bonding of a primary stator elastomer to a rigid support structure which in the case of a composite PCP tends to be a thermoset material. Such an approach can generate a more fully bonded stator elastomer to structural thermoset system by incorporating a compatabilizing tie-layer that, for example, incorporates elements of both an elastomer and a thermoset material, enabling it to complete covalent bonding reactions with both. By avoiding the use of a solvent based adhesive system and utilizing a compatabilizing hybrid material, also known as a tie layer, a more robust bonding of the elastomer and thermoset can be generated through covalent bonding of each material; chemically crosslinking the elastomer to the thermoset. As such a limiting factor to the bond can now be transferred to mechanical and chemical stability of the elastomer or thermoset and no longer a third material susceptible to adhesive failure from aging.

As explained, geometry of a standard PCP stator can makes it inherently a source of elastomer inconsistencies. The shape profile can describe an eccentric displacement that results in uneven sections of elastomeric material. A thick uneven elastomer wall can exhibit several drawbacks that can result in it being a primary source for failure down hole.

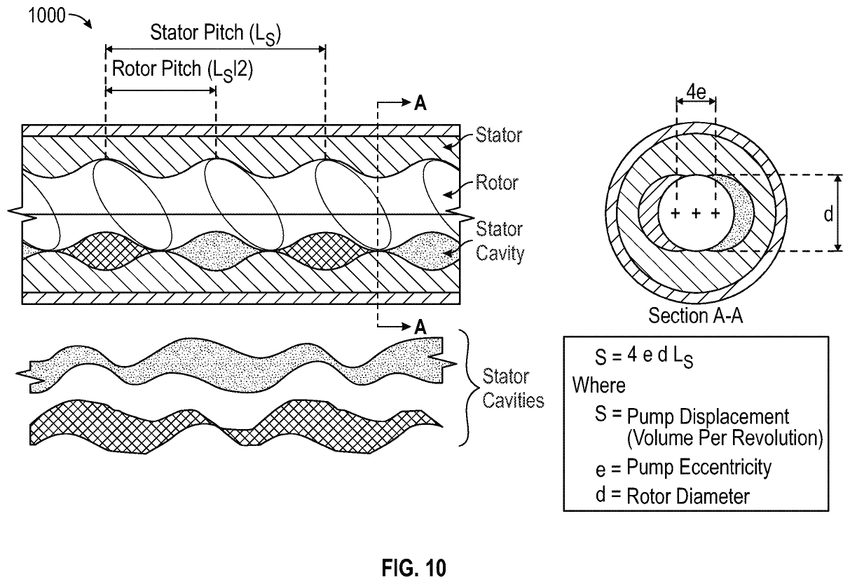

FIG. 10 shows an example of a PCP 1000 with various types and ranges of motions that can impact various components, particularly when exposed to downhole conditions. Specifically, there can be swell of elastomer where, because the wall is uneven, when exposed to downhole fluid and gas, the stator elastomer can swell unevenly, resulting in stator fit mismatch that can result in reduced pumping efficiency and damage to the elastomer. Further, as to heat dissipation, elastomeric materials tend to be inherently good thermal insulators. As a result, heat generated from the dynamic oscillation of the elastomer wall can buildup in the thick elastomer portions and eventually lead to thermal degradation of the elastomer.

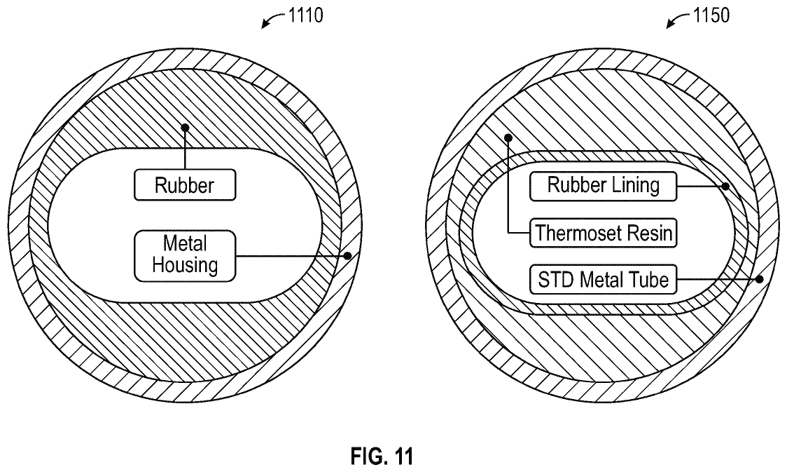

FIG. 11 shows examples of two PCPs 1110 and 1150. A composite PCP stator in the PCP 1150, compared to the PCP 1110, can reduces the primary degradation mechanisms in the elastomer by a construction designed to mitigate several failure modes. The composite design separates structural and dynamic pumping functions of the stator and selects materials that are optimized to perform each function. The shape of the lobed stator may be defined by a rigid, thermally conductive structural composite material. This material can be less susceptible to swell, but also may optionally provide improved heat dissipation away from the inner layer. The inner layer of the composite PCP stator design 1150 includes an elastomer material that may be applied with a desired wall thickness (e.g., an even-wall thickness or other desirable wall thickness) over one or more surfaces of a structural composite.

As an example, a composite PCP stator construction may be designed with a compilation of layers including but not limited to a thermoset region and an elastomer layer advantageous to the application. For a stator application, an elastomer can be designed for dynamic operation, mechanical robustness, resistance to well fluid resistance, and excellent thermal stability while the thermoset is designed for heat dissipation, structural rigidity, and dimensional stability.

As explained, one or more compatabilizing layers may be utilized to allow for more complete and permanent bonding of these dissimilar materials (e.g., dynamic elastomer to structural thermoset).

A compatabilizing layer can facilitate bonding of an elastomer to a rigid support structure which in the case of the composite PCP can be a thermoset material. A tie layer can be a compatabilizing tie layer that is designed with several potential advantages, which can include one or more of permanent bonding, improved aging and bond facilitation.

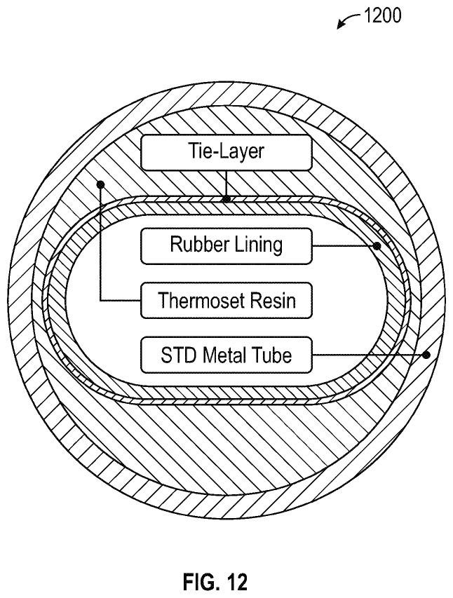

FIG. 12 shows an example of a PCP with a tie-layer adjacent to a thermoset resin and a rubber lining where the PCP includes a metallic tube for a housing (e.g., exterior shell).

As to permanent bonding, often elastomers are bonded using an adhesive material, which “glues” the two layers together, typically resulting in mechanical bond combined with van der Waals forces. In the case of highly reactive adhesives, it is possible to form chemical covalent bonds to a surface. However, the reactive chemistries frequently used for these adhesives typically can be susceptible to chemical and thermal degradation at downhole conditions. Typically, for those materials to contain sufficient reactivity to act as an adhesive (e.g., low viscosity, high surface energy), the material is less robust to chemical attack and aging. As explained, a compatabilizing tie layer can include thermoset reactive functionality along with elastomer reactive functionality. Such an approach allows a tie-layer to co-cure with both an elastomer layer and a thermoset later, resulting in a covalently bonded system. By providing a custom formulated layer that integrates into both the structural thermoset and the elastomer, robust bonding can occur using the same high-performance materials each individual layer is utilizing.

As to aging, a tie-layer system may employ a common base chemistry and a common cure system as stator and thermoset regions to achieve desired bonding. Desirable properties for mechanical stability, chemical resistance, swell, embrittlement, softening, etc., can be imparted through use of a tie-layer system where they may no longer be weak points in the bonding of the layers.

As to bond facilitation, a tie-layer may be an additional layer that is a layer to facilitate bonding. For maximum resistance to the downhole fluids and gases that a pump may encounter, a primary rubber lining of an elastomer stator may be formulated using one or more elastomer materials with inherently low reactivity and high degree of saturation in the polymer backbone. As a result of this high saturation and low reactivity, elastomers based on these systems tend to be inherently difficult to bond. As an example, a tie-layer material may be an elastomer with properties that may be selected or otherwise tailored to be similar to a stator elastomer and, for example, with greater unsaturation in a polymer backbone. In such an approach, greater unsaturation enables bonding to be much easier and more complete with adhesives. As such an approach still utilizes an elastomer that can have similar properties to a primary stator elastomer, a method can include co-vulcanizing with a primary elastomer liner.

As to an example of a tie-layer, considering a composite PCP construction where the primary stator liner is HNBR and the structural thermoset composite is an epoxy resin system, an example tie-layer system may include an elastomer compound that contains (e.g., or is wholly comprised of) a co-functional system.

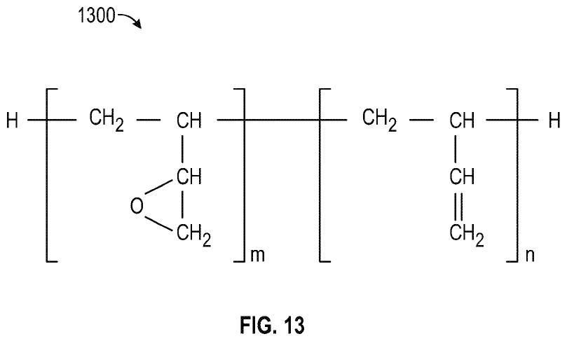

FIG. 13 shows an example of a co-functional system 1300 that includes polybutadiene with grafted epoxide functionality. As shown in the example of FIG. 13, a polymeric molecule can include one functionality that is an epoxide reactive group while another functionality is a pendant vinyl group able to vulcanize with an elastomer material. Such materials can find use as epoxy toughening agents (e.g., consider resins from Cray Valley USA, LLC, NAGASE & CO., LTD., Nisso America Inc., etc.). A tie-layer system may also incorporate fillers (e.g., carbon black, clay, silica, etc.) antioxidants, process aids and/or oils, curative systems, etc. A tie-layer may also utilize increased unsaturation to provide more sites for co-vulcanization with a primary elastomer material.

As an example, stator elastomers may include, but are not limited to, one or more of NBRs, HNBR aFKM and FEPM. As an example, a tie-layer material may be modified based on a stator elastomer in order to match a vulcanization system used in the elastomer. As an example, a tie-layer material may be modified to match a base resin and cure system of a structural thermoset.

As to some examples of thermosetting chemistries for high temperature bonding applications, these may be based on cyanoacrylate, acrylate, polyester, epoxy, benzoxazine, polyimide, bismaleimide, and/or cyanate ester chemistry. While robust in many uphole applications, these thermosets may be limited in chemical compatibility and high-temperature capability. For example, with high-temperature exposure with small amounts of water, these polymers may be susceptible to hydrolytic attack, which results in a depolymerization reaction of the material and subsequent loss of adhesion.

However, a range of resin chemistries for encapsulation are available. Such resin chemistries can offer low viscosity processing, high glass transition temperatures, excellent electrical/mechanical/thermal properties, and hydrolysis resistant chemistries. These materials can be formulated for the material to be used at temperatures up to 300 C (572 F).

As an example, a polymer may be a thermosetting polymer. As an example, a polymer may be a non-thermosetting polymer. As an example, a polymeric material may include a mixture of one or more thermosetting polymers and one or more non-thermosetting polymers. A US Patent Application Publication having Pub. No. US20210288541A1, published 16 Sep. 2021, is incorporated by reference herein in its entirety, and describes various types of polymers, pumps, etc.

As an example, a polymeric material may be or include an ethylene propylene diene monomer (M-class) rubber (EPDM), which is a type of synthetic rubber that is an elastomer. As an example, a polymeric material may be or include a nitrile butadiene rubber (NBR), which is a family of unsaturated copolymers of 2-propenenitrile and various butadiene monomers (1,2-butadiene and 1,3-butadiene). As an example, a polymeric material may be or include polyether ether ketone (PEEK), which is an organic thermoplastic polymer in the polyaryletherketone (PAEK) family. As an example, a polymeric material may be or include polyvinylidene fluoride, or polyvinylidene difluoride (PVDF), which is a thermoplastic fluoropolymer produced by the polymerization of vinylidene difluoride. The aforementioned EPDM, NBR (e.g., also consider HNBR), PEEK, PAEK and PVDF materials are given as some examples of types of polymers that may be in a polymeric material.

Epoxy resins, also known as polyepoxides are a class of reactive prepolymers and polymers which contain epoxide groups.

Maleimide and its derivatives can be prepared from maleic anhydride, for example, by treatment with amines followed by dehydration. A feature of the reactivity of maleimides is their susceptibility to additions across the double bond either by Michael additions or via Diels-Alder reactions. Bismaleimides are a class of compounds with two maleimide groups connected by the nitrogen atoms via a linker. Bismaleimides can be used as crosslinking reagents (e.g., in polymer chemistry).

Polybutadiene is a synthetic rubber that is a polymer that can be formed from the polymerization process of the monomer 1,3-butadiene.

Oxazines are heterocyclic compounds that include one oxygen atom and one nitrogen atom. Isomers exist depending on the relative position of the heteroatoms and relative position of the double bonds. Derivatives may also referred to as oxazines, examples include ifosfamide and morpholine (tetrahydro-1,4-oxazine).

Cyanate esters include an —OCN group. Cyanate esters can be cured and/or postcured by heating. As an example, curing may be alone at elevated temperatures or, for example, at lower temperatures in presence of a suitable catalyst. As an example, a catalyst may be a transition metal complex such as, for example, one that includes cobalt, copper, manganese and/or zinc. As an example, cyanate esters can be used to produce a thermoset material with a relatively high glass-transition temperature (Tg), for example, up to about 400 degrees C. with a relatively low dielectric constant. A cyanate ester material may exhibit relatively low moisture uptake and a higher toughness compared to epoxies.

Silicones are polymers that include repeating units of siloxane. Silicones can be relatively heat-resistant and/or rubber-like, for example, consider examples such as silicone oil, silicone grease, silicone rubber, silicone resin, and silicone caulk.

Ring-opening metathesis polymerization (ROMP) is a type of olefin metathesis chain-growth polymerization. Reactions can be driven by relief of ring strain in cyclic olefins (e.g. norbornene, cyclopentene, etc.). A catalyst that may be used in a ROMP reaction can include a metal, for example, consider a RuCl₃/alcohol mixture, a catalyst, etc. As an example, a catalyst can be a transition metal carbene complex. For example, consider benzylidene-bis(tricyclohexylphosphine)-dichlororuthenium, [1,3-bis-(2,4,6-trimethylphenyl)-2-imidazolidinylidene]dichloro(phenylmethylene)(tricyclohexylphosphine)ruthenium, Dichloro(o-isopropoxyphenylmethylene)(tricyclohexylphosphine)ruthenium(II), and [1,3-Bis-(2,4,6-trimethylphenyl)-2-imidazolidinylidene]dichloro(o-isopropoxyphenylmethylene)ruthenium.

As an example, a polymer may be formed at least in part via ROMP. For example, as a prepolymer component amenable to forming a polymer via ROMP, consider a carbon backbone with functional groups that include at least one oxygen that provides an amount of hydrophilicity may be present along with a hydrocarbon chain (e.g., carbon backbone) that provides an amount of hydrophobicity where at least one functional group may be present on the hydrophobic hydrocarbon chain where such a functional group may participate in ROMP (e.g., via relief of ring stress). In such an example, the prepolymer component may be an ester such as a diester, a triester, etc. (e.g., an n-ester). As an example, consider a triester that includes at least one hydrocarbon chain with a functional group that includes a ring that is amenable to ROMP via relief of ring stress.

As mentioned, a ROMP process can employ a catalyst that can include a metal (e.g., Ru, etc.). As an example, a ROMP process may be utilized to form a copolymer (e.g., via two monomers, three monomers, etc.). For example, consider a scheme for forming a copolymer utilizing a functionalized triester as one of the monomers. As an example, DILULIN material (Cargill Inc., Minneapolis, MN) may be utilized, which is a mixture of norbornyl-functionalized linseed oil and cyclopentadiene (CPD) oligomers (e.g., one fraction consisting of modified linseed oil at about 70 percent by weight and another of cyclopentadiene (CPD) oligomers at about 30 percent by weight). In such an example, the norbornene groups are ROMP-reactive. In such a scheme, one or more additional materials can be included such as, for example, one or more of dicyclopentadiene (DCPD) and ethylidenenorbornene (ENB) (e.g., to form a copolymer, which may be a terpolymer, etc.). At room temperature, DCPD is a white crystalline solid. Norbornene is a bridged cyclic hydrocarbon that can be provided as a white solid. Norbornene includes a cyclohexene ring with a methylene bridge between C-3 and C-6; it carries a double bond which induces ring strain. ENB is a bicyclic monomer and intermediate that includes two double bonds, each with a different reactivity. ENB can be produced from vinyl norbornene, which can be made from butadiene and dicyclopentadiene DCPD.

As an example, a terpolymer may be a DCPD/ENB/DILULIN terpolymer (DED terpolymer). Synthesis of such a terpolymer may proceed at least in part via ROMP. For example, DED terpolymer can be cured via ROMP using transition metal chlorides (e.g., WCl₆, hexachloro tungsten) in combination with Lewis-acidic co-catalysts (e.g., EtAlCl₂, ethylaluminum dichloride). As an example, a DED terpolymer can also be cured with transition metal complexes (e.g. titanium, tungsten, molybdenum, ruthenium, osmium, etc.) with organic ligands. As an example, cationic polymerization can be accomplished using one or more cationic catalysts, such as, for example, one or more of BF₃·O(C₂H₅)₂ (boron trifluoride ethyl etherate), B(C₆F₅)₃ (tris (pentafluorophenyl) borane), MAO (methylalumoxane), VCl₄ (tetrachlorovanadium), and AlBr₃ (tribromoalumane).

While a terpolymer is mentioned as an example of a copolymer, in general, one or more types of copolymers may be synthesized. For example, consider a DCPD/DILULIN copolymer (DD copolymer) or an ENB/DILULIN copolymer (ED copolymer).

As mentioned, a copolymer thermosets can be synthesized from DCPD and/or ENB as well as a functionalized oil (e.g., as in the DILULIN material, etc.). Such synthesis can include ring opening metathesis polymerization (ROMP), which may employ a catalyst or catalysts (e.g., 2nd generation Grubbs' catalyst, etc.). The DILULIN material includes norbornyl-functionalized linseed oil synthesized by Diels-Alder reaction of linseed oil and DCPD at high temperatures and pressures. The DILULIN oil component, a triester, has an average of less than one bicyclic moiety per triglyceride. The low reactivity of the DILULIN material due to the low number of bicyclic moiety compared to DCPD and ENB can decrease curing kinetics, which can, for example, provide time for one or more filling and/or impregnation process (e.g., before gelation, a transition from liquid to solid). As an example, the relatively low viscosity of DCPD and/or ENB may be controlled by adding different concentrations of the DILULIN material.

As an example, a terpolymer or other copolymer formed via use of a functionalized n-ester and ROMP, may exhibit toughness and adhesion (e.g., via presence of the n-ester structure).

As an example, a copolymer formed at least in part from a functionalized n-ester. For example, the aforementioned DED copolymer thermoset may be utilized. Such DED copolymer thermosets have relatively high toughness at relatively high temperature and pressure, which may extend service time. As an example, due to the relatively low viscosity and ability to manipulate processability and thermal conductivity, a copolymer based at least in part on a functionalized n-ester may be useful as, for example, a potting material, an encapsulation material, etc., particularly for relatively extreme environments.

As an example, a copolymer material formed at least in part from a functionalized n-ester and ROMP can be utilized where high Tg, high toughness thermoset resins with a very low curing temperature are presently used. As an example, such a copolymer material may replace one or more of phenolic and epoxy materials (e.g., while providing improved properties and processability).

A pre-ceramic polymer can be a polymer that can be heated to elevated temperature or pyrolyzed to form a ceramic material. For example, consider polycarbosilanes, with a carbon-silicon backbone, that produce silicon carbide on pyrolysis and polysiloxanes, with a silicon-oxygen backbone, that produce silicon oxycarbides on pyrolysis.

As an example, a polymer composite material can include a polymer matrix that is an organic or inorganic polymer matrix (e.g., one or more of epoxy, bismaleimide, polybutadiene, benzoxazine, cyanate ester, silicone, Ring-Opening Metathesis Polymers (ROMP), preceramic polymers) or a mixture thereof.

As an example, a polymer composite material can be cured by application of heat and can be used as either a solvent free system or dispersed in solvent to aid in viscosity reduction. As an example, a polymer composite can be obtained through use of a polymer matrix filled with particulate filler. As an example, particulate filler can include one or more of aluminum oxide, aluminum nitride, boron nitride, silicon nitride, and beryllium oxide.

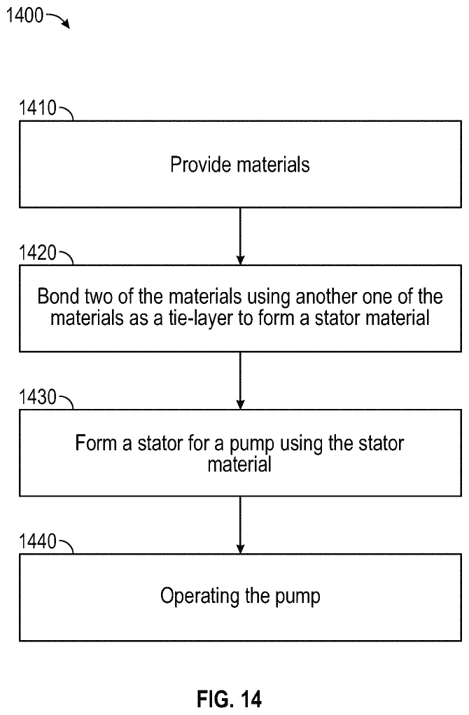

FIG. 14 shows an example of a method 1400 that includes providing materials 1410; bonding two of the materials using another one of the materials as a tie-layer to form a stator material 1420; forming a stator for a pump using the stator material 1430; and operating the pump 1440.

A fluid displacement pump can include a rotor; and a stator, where the stator includes two materials bonded by a tie-layer material. In such an example, the two materials can include a thermoset and an elastomer.

As an example, a fluid displacement pump can include a motor operatively coupled to a rotor. As an example, a fluid displacement pump can include a fluid inlet and a fluid outlet. In such an example, a rotor may be driven by fluid flowing from the fluid inlet to the fluid outlet.

As an example, a fluid displacement pump can include a housing where, for example, a stator is disposed at least in part in a bore of the housing.

As an example, a method can include providing materials; bonding two of the materials using another one of the materials as a tie-layer to form a stator material; forming a stator of a pump using the stator material. In such an example, one of the two materials can include an elastomer and another one of the two materials can include a thermoset.

As an example, bonding can include chemical bonding and/or one or more other types of bonding.

As an example, a stator can be disposed at least in part in a bore of a housing where, for example, the housing can be a metallic housing.

As an example, a tie-layer may be shaped and/or sized for one or more purposes. As an example, a number of tie-layers may be utilized for a number of interfaces. As an example, a tie-layer may be uniform or may be non-uniform. As an example, a non-uniform tie-layer may be shaped and/or sized and/or formulated to handle one or more types of stresses (e.g., due to operational conditions, etc.).

As an example, one or more layers may be formed using one or more types of processes. For example, consider one or more of a taping process, a painting process, a spraying process, an extrusion process, etc. In various instances, a process or processes may impart a desired roughness, which may be referred to as a surface shape, for example, as a type of surface characteristic. As an example, one surface of a layer may have one type of roughness and another surface of a layer may have another type of roughness. As an example, a process or processes may be utilized to generate roughness in one or more elastomer layers.

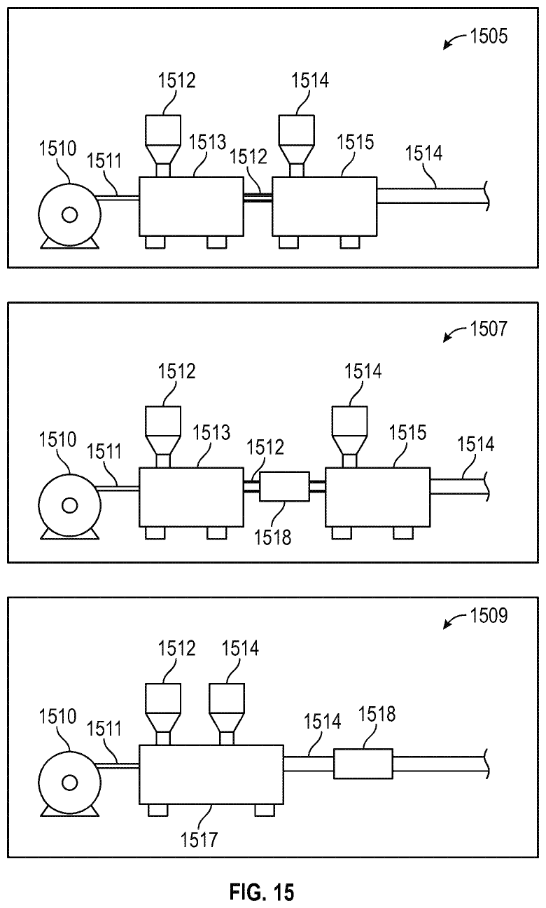

FIG. 15 shows examples of processing equipment 1505, 1507 and 1509. As shown, the processing equipment 1505 can include a reel 1510 that carries a component 1511 for translation to a first extruder 1513 fed with a first material 1512 that can be extruded about the component 1511 and then translated to a second extruder 1515 fed with a second material 1514 that can be extruded about the first material 1512. In such an example, the component 1511 may be a core that may be part of an assembly (e.g., a layer, etc.) or that may be a processing core that is utilized for purposes of support by having a body to deposit material onto the body. Where the component 1511 is not to be part of a finished assembly, it may be removed. For example, consider a core that can be removable via one or more mechanisms (e.g., collapsible responsive to force, translatable, rotatable, etc.). As an example, the component 1511 may include one or more features that may impart roughness to an extruded layer that is extruded onto the component 1511.

As an example, one or more processing conditions may be adjusted to allow for an amount of surface modification of the first material prior to deposition of the second material. In such an example, the amount of surface modification may correspond to curing of the first material. Such an example may allow for control of an amount of cross-linking of the second material to the first material.

As shown, the processing equipment 1507 can include the reel 1510 that carries the component 1511 that can be translated to the first extruder 1513 fed with the first material 1512 that can be extruded about the component 1511, and then translated to the second extruder 1515 fed with the second material 1514 that can be extruded about the first material 1512. The processing equipment 1507 further includes equipment 1518, which may be, for example, one or more types of equipment that can be used to alter properties of the first material 1512. For example, the equipment 1518 can be a hot air oven that can expedite curing of at least a portion of the first material 1512 prior to entry to the second extruder 1515. In such an example, the curing may alter surface properties of the first material 1512 in a manner that impacts cross-linking of the second material 1514 to the first material 1512.

As an example, one or more processing conditions (e.g., optionally of the equipment 1518) may be adjusted to allow for an amount of surface modification of the first material prior to deposition of the second material. In such an example, the amount of surface modification may correspond to curing of the first material. Such an example may allow for control of an amount of cross-linking of the second material to the first material.

As shown in FIG. 15, the processing equipment 1509 includes various components of the processing equipment 1505; however, a single extruder 1517 is included that can co-extrude the first material 1512 and the second material 1514. In such an example, the first and second materials 1512 and 1514 may be deposited in a simultaneous manner about the component 1511 as the component 1511 is translated through the extruder 1517.

As shown, the processing equipment 1509 may optionally further include equipment 1518, which may be, for example, one or more types of equipment that can be used to alter properties of the first material 1512 and/or the second material 1514. For example, the equipment 1518 can be a hot air oven that can expedite curing.

As an example, a manufacturing process can include extruding polymeric material and heating the material to about 200 degrees C. or more (e.g., about 392 degrees F. or more) for about several minutes for polymerization, curing, vulcanizing, etc. As an example, a curing temperature may be about 200 degrees C. to about 205 degrees C. (e.g., about 392 degrees F. to about 401 degrees F.).

As an example, heat loss or cooling may occur for extruded material or materials. For example, extruded material may cool approximately to an ambient temperature (e.g., a room temperature of about 5 degrees C. to about 40 degrees C.).

As an example, a process can include post-curing, for example, after passing extruded material through a heater.

As an example, a polymerization process may be characterized at least in part by a curve such as, for example, a vulcanization curve, which can exhibit an increase in viscosity of polymeric material during crosslinking. As an example, a steepness of a curve can be affected by the nature of one or more additives (e.g., accelerator(s), etc.). As an example, a process may control polymerization, extrusion, etc. (e.g., at a particular point in time along a viscosity curve, modulus curve, polymerization curve, etc.). As an example, a curve may correspond to one or more material states of a material (e.g., molten, crystallized, polymerized, etc.).

As an example, a method can provide for generation of surface roughness during an extrusion process (e.g., pre-vulcanization) in an elastomer. In such an example, the surface roughness can provide for mechanically enhanced bonding of the elastomer to a thermosetting structural composite for a PCP stator or another type of stator.

As an example, a method can provide for generation of in-situ surface roughness during vulcanization in an elastomer. In such an example, the surface roughness can provide for mechanically enhanced bonding of the elastomer to a thermosetting structural composite for a PCP stator or another type of stator.

As an example, a method can provide for generation of surface roughness after vulcanization in an elastomer. In such an example, the surface roughness can provide for mechanically enhanced bonding of the elastomer to a thermosetting structural composite for a PCP stator or another type of stator.

As explained, for a PCP application, a stator may be an injectable elastomer that a rotor moves against where, over time, the elastomer may degrade and/or swell from exposure to the downhole environment (e.g., fluid, conditions, etc.). In various scenarios, PCP applications manage stator deterioration by swapping rotors at the surface. However, with an electric submersible progressive cavity pump (ESPCP) being fully submerged, the stator is exposed to harsh conditions for a longer time than non-ESPCP stators. As such a ESPCP stator can benefit from an ability to withstand harsh conditions to make an ESPCP system a viable alternative for low flow unconventional applications.

As an example, a method can provide for enhancing bonding for a tie-layer. As explained, a tie layer can be designed to bond two dissimilar materials by blending reactive functionality from each material and forming a covalently bonded bridge between the materials. With a properly designed tie layer, blending of the reactive functionality for each layer for bonding may be part of a solution that to create an effective covalent bond where another part of the solution can provide for an increase in surface area, for example, through introduction of surface roughness, which may provide for more bonding area and/or for mechanical linking. As an example, mechanical linking can involve physical contact that may provide for multidirectional contact forces at an interface. In comparison to an annular approach, which may be characterized by a normal to a surface (e.g., radial direction), surface roughness may be characterized by normals to a rough surface that point in multiple directions. As an example, hoop stress may also be altered by using surface shaping (e.g., surface roughness). Hoop stress is the stress that occurs along a circumference of a tube when pressure is applied. For a tube, hoop stress acts perpendicular to the axial direction. Hoop stresses are tensile and generated to resist the bursting effect that results from the application of pressure. Hoop stress may be referred to as a tangential stress or circumferential stress.

Hoop stress is a function of tube diameter and wall thickness, the magnitude of which changes as these dimensions vary. Hoop stresses can separate top and bottom halves of a tube. Computation of hoop stress can considers the total force on half of a thin-walled tube, due to internal pressure. As surface roughness can impart a change in radius and/or a change in thickness, it can affect hoop stress.

As an example, a process may involve layering where one or more layers has or imparts a particular type of stress. For example, consider a layer acting as a compression sleeve such that it applies force to an inner layer. As another example, consider a layer as a tension sleeve such that it applies force to an outer layer. As an example, one or more layers may be formed to apply one or more desirable forces that can help with bonding. As explained, surface roughness may be a particular approach. As an example, another approach may depend on polymerization, vulcanization, bonding, etc., where, for example, a material changes its internal stress state responsive to a chemical process and/or a physical process.

As explained, vulcanization can be, in contrast with thermoplastic processes (e.g., a melt-freeze process that characterizes behavior polymers), generally irreversible; noting that curing of other thermosetting polymers, is generally irreversible.

In a vulcanization process of elastomeric components, geometry of a finished component can undergo different degrees of shrinkage after demolding. For example, the ratio of the difference between the size of the mold and the size of the finished component after vulcanization can define shrinkage (e.g., the shrinkage of rubber may be generally between 1 percent and 3 percent). For example, a rubber grommet with a mold diameter of 150 mm can result in a finished rubber grommet with a diameter of 147 mm after vulcanization (e.g., the shrinkage amount is 3 mm, and the shrinkage ratio is 2 percent). If an elastomeric component is not free standing, it may not shrink appreciably. For example, an elastomeric component extruded onto a support (e.g., whether part of an assembly or not), may retain an inner dimension that corresponds to the support (e.g., assuming the support is sufficiently stiff).

As to surface roughness, while it may offer some opportunity for pulling away in one or more directions due to shrinkage (e.g., possibly reducing mechanical coupling), the overall effect of shrinkage of a layer may provide for enhanced mechanical coupling with respect to another layer (e.g., an inner layer).

As explained, there can be a limitation to bondability of dissimilar materials as they diverge from each other and/or where reactive functionality of layers is minimal. To enhance bonding, an assembly may use of a tie layer that provides for covalent bonding; however, as explained, that may be part of a solution. In various instances, for example, where a tie layer may not fully support forces being applied to bonded layers, surface roughness may be utilized as another part of the solution. For example, a method can include utilizing surface roughness generated from an extruder in an extrusion process to enhance mechanical anchoring along with covalent bonding between the two dissimilar materials to elevate robustness of the bonding. As an example, a method may implement a tie layer scheme for bonding layers in a low flow ESPCP stator, which can be utilized to produce an effective tie layer or materials, which, in various instances, may traditionally not be capable of being tied together.

As an example, one or more techniques may be utilized to achieve enhanced bonding through a modified tie layer with increased surface roughness generated from an extruder in an extrusion process. For example, consider a method that includes manipulating an extrusion process to form rough surface features conducive for mechanical anchoring to generate enhanced bonding of dissimilar materials. Such an approach can form enhanced performance stators that can be suitable for low flow ESPCP. As an example, surface roughness may take one or more forms. For example, consider splines, dimples, ridges, peaks, valleys, etc.

The geometry of a PCP rotor makes it inherently a source of elastomer inconsistencies. Its shape profile describes an eccentric displacement that results in large uneven sections of elastomeric material, the primary source for failure down hole. For example, consider the example of FIG. 10, which shows PCP geometry with rotor eccentricity.

As explained with respect to FIG. 11, a composite stator can reduce primary degradation mechanisms in an elastomer by a construction designed to mitigate several failure modes. Such a stator can provide for thermal management to dissipate heat generated during a pumping process, where an enhanced elastomer formulation is not constrained by standard PCP injection processes and thin walled material to eliminate hysteresis effects from dynamic loading.

As mentioned, a stator construction can be designed with a compilation of layers including but not limited to a thermoset region, a thin tie layer of a thermoset/elastomer blended region, and an elastomer layer advantageous to the application. For the stator application, the elastomer can be designed for dynamic, mechanical, fluid resistance, and chemical attach, while the thermoset can be designed for thermal management, structural support, and dimensional stability. As a result, dissimilar materials demand a custom designed tie layer to bond the materials together. The divergence of some of the potential elastomer and thermoset compounds may demand an additional bonding mechanism to enhance covalent bonding of the elastomer and thermoset.

As an example, a method can utilize a pre-vulcaninzed elastomer to manipulate surface roughness of an extrudate to create a rough surface with increased surface area for additional bonding and/or mechanical anchoring. In such an example, mechanical anchoring can be achieved by a thermoset filling surface cavities and curing in valleys of a rough topography in a tie layer. Once the thermoset has solidified, the rigidity of the thermoset can lock the tie layer into the composite. As a result, failure of the bonding would involve the tie layer failing cohesively and a delamination in an adhesive fashion, which would be hindered due to the physical entrapment of the elastomer by the thermoset. Further, the surface roughness can create additional support in the bond by increasing surface area available for bonding. For elastomer and thermoset configurations where base layers are relatively inert and functionally reactive sites are limited, expanding the surface area can allow for additional covalent bonding to again assist is improving the bonding ability of the tie layer material.

As an example, a method may implement one or more schemes such as, for example, (1) imparting surface roughness directly via an extruder head and/or (2) shortly after extrusion through the use of texturing equipment.

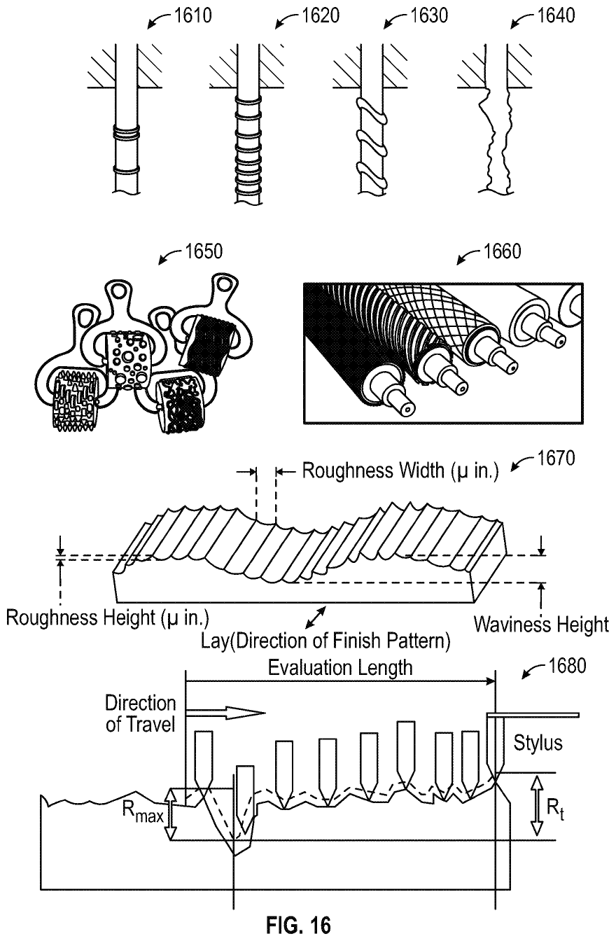

FIG. 16 shows various examples of surface roughness, including 1610, 1620, 1630 and 1640, which are examples of extrusion generated surface roughness. As to the examples 1650 and 1660, these show textured rollers (e.g., patterned rollers) for imprinting a texture (e.g., a pattern) on a surface and examples of elastomer lengths with surface textured. FIG. 16 also shows an example for characterizing surface roughness 1670 and an example of measuring surface roughness 1680. As an example, surface roughness may be generated in one or more manners.

Surface roughness may be characterized using one or more techniques, conventions, etc. For example, consider use of one or more of parameters such as Ra, Rsk, Rq, Rku, Rz, etc., for use in measuring surface finish.

The parameter Ra is for average surface roughness, which is the average roughness between a roughness profile and the mean line. An Ra surface finish chart may be used for absolute values. The parameter Rmax is for vertical distance from peak to valley. This roughness parameter may be used for various types of features. The parameter Rz is for average maximum height of a profile, unlike Ra, Rz measures the average values of the five largest differences between peaks and valleys. The measurement may be performed using five sampling lengths, and it may help to reduce error as Ra can be insensitive to some extremes. As to Rk, it may be a family of parameters suitable for use with tubes (e.g., bore linings, etc.).

As to a surface finish (e.g., roughness) table, such a table can compare the different surface roughness scales for manufacturing processes. Various parameters may include Ra (roughness average), RMS (root mean square), CLA (center line average), Rt (roughness total), N (new ISO (Grade) scale numbers), Cut-off Length (e.g., length required for sample), etc.

As an example, a table such as the table below may be utilized to characterize roughness, noting that larger values may be imparted (e.g., Ra greater than 50 μm).

| Roughness, | Roughness values, Ra | | | Center | Rough- |
|---|---|---|---|---|---|
| N | micro- | micro- | | line avg., | ness, |
| ISO grade | meters | inches | RMS | CLA | Rt |
| numbers | (μm) | (μin.) | (μin.) | (μin.) | (μm) |
| N12 | 50 | 2000 | 2200 | 2000 | 200 |
| N11 | 25 | 1000 | 1100 | 1000 | 100 |
| N10 | 12.5 | 500 | 550 | 500 | 50 |
| N9 | 6.3 | 250 | 275 | 250 | 25 |
| N8 | 3.2 | 125 | 137.5 | 125 | 13 |
| N7 | 1.6 | 63 | 69.3 | 63 | 8 |
| N6 | 0.8 | 32 | 35.2 | 32 | 4 |
| N5 | 0.4 | 16 | 17.6 | 16 | 2 |
| N4 | 0.2 | 8 | 8.8 | 8 | 1.2 |
| N3 | 0.1 | 4 | 4.4 | 4 | 0.8 |
| N2 | 0.05 | 2 | 2.2 | 2 | 0.5 |
| N1 | 0.025 | 1 | 1.1 | 1 | 0.3 |

As an example, roughness may be quantified by deviations in the direction of the normal vector of a real surface from its ideal form. In surface metrology, roughness can be considered to be the high-frequency, short-wavelength component of a measured surface. As an example, amplitude and frequency may be utilized to characterize roughness.

As an example, roughness may be characterized by a pattern. Such a pattern can include individual features that may be distributed with spacing therebetween. For example, a feature may be a peak or a valley where spacing exists between peaks and/or valleys. As an example, a feature may be linear, curved, linear and curved.

As to extruder generated surface roughness, it may be created in various ways including, but not limited, to temperature management, internal die geometry, extruder speeds/ratios, manipulating the landing length of the tooling, and increased coefficient of friction in the tooling. As to thermal management of the extrudate, it can have a substantial impact to a surface finish of a product. For example, by modifying the exit temperature of the elastomer, the viscosity is affected. Consequently, by lowering the temperature of an extrusion process, increased shear stress above the critical shear rate of the polymer can occur. In such an example, the reduction in temperature can cause a distortion (e.g., surface roughness) known as melt fracture.

As an example, melt fracture may also be generated by modifying an internal die geometry. Geometrical changes can have a direct effect on shear stress in a polymer. As a result, changes to tooling exit angles, tight die gap, and/or flow pathways can affect melt fracture results. Such changes to flow pattern of a polymer can generate substantial shear stress above a critical shear rate. Similar to how temperature effects polymer viscosity and consequently internal shear, tooling geometry can create a skin rupture of the polymer that happens when the polymer is stretched too quickly as it leaves the die. As the polymer exits the die, the internal shear in the polymer can cause micro tearing at the surface generating a rough surface in the polymer. Additionally, tooling modifications such as excessive tooling land length or tooling surface friction can generate similar effects to the polymer. However, these features may generate a stick and slip phenomenon in the extrudate where the extruder pressure pulses during extrusion. This pressure generated pulse comes from the elastomer sticking to metal surfaces and then breaking loose again causing micro tears in the surface of the polymer extrudate. Extrusion speeds can also be modified to generate either a skin rupture phenomenon by extruding at a speed fast enough to generate critical shear in the polymer or by pulsing the extruder during the operation to simulate the stick and slip phenomenon caused by high surface friction.

As an example, one or more gas jets may be utilized, which may have temperature controlled gas. In such an example, fluid dynamics may provide for imparting surface roughness along with, for example, viscosity control and/or other temperature-related control. As an example, one or more lasers may be utilized to impart surface roughness. For example, consider pulsing of multiple lasers, moving a laser, etc., where one or more beams can interact with material for purposes of heating, ablation, etc.

As an example, surface roughness generated by reforming the surface of a polymer once melt processed can be created in various manners, including, but not limited to, rollers with stamped surfaces, assorted brushes, tooling with simulated die drool for surface scoring, and assorted cutters.

After melt processing, a surface of an elastomer may be soft and readily malleable. As a result, utilization of one or more rollers with a stamped surface can provide a repeated texture to the surface of the elastomer. Such a texture can then be utilized to enhance bonding of the elastomer to a thermoset. In a similar manner, one or more of assorted brushes can be used to generate one or more of a random surface roughness, which can be capable of enhancing the elastomer bonding to a thermoset material. Similar to the rollers and brush method, modifications to a processing tooling can generate surface features as well. Consider an example that creates extrusion tooling with a simulated die drool on the end. In such an example, the material at the edge of the die can form surface roughness as well. In these types of processes, the surface roughness may be generated by imprinting and removal prior to vulcanization.

As an example, processing equipment can include in-line partial vulcanization equipment. Typically, for a progressive cavity pump stator, elastomer is cured in an autoclave. While this process is reliable and effective for vulcanization, it allows the elastomer to heat up and “flow” under pressure prior to curing. As a result, a traditional autoclave process may be insufficient to impart surface modification. However, with an in-situ vulcanization process, surface texture can be “locked in” through a partial vulcanization at the surface. For example, consider use of one or more of an in-line oven with inert gas, microwaves, electron beam irradiation, or similar processes. In such an example, during a final cure process, the surface can be cross-linked sufficiently enough to prevent elastomer flow and consolidation.

An extruder generated surface roughness can provide for improving the bonding of higher performance elastomers and thermosets that may be quite dissimilar, for example, where blending functionality in a tie layer may offer somewhat marginal covalent bonding functionality. Elastomers may be selected from various types of elastomers. For example, consider one or more of FKMs and FFKMs; noting that other types of elastomers may be utilized, additionally or alternatively.

Common thermosetting chemistries for bonding applications tend to be based on either polyester, epoxy, benzoxazine, polyimide, bismaleimide, or cyanate ester chemistry. While robust in many uphole applications, these thermosets tend to be limited in chemical compatibility and high-temperature capability. For example, with high-temperature exposure with small amounts of water, such polymers can be susceptible to hydrolysis. Hydrolysis causes a reduction in glass transition temperature and weakening of the polymer from a mechanical perspective. Additionally, for applications where the temperature is above 175-200 deg C., the detrimental effect can be much greater.

As an example, one or more types of resin chemistries for encapsulation may be utilized. Such resin chemistries can offer low viscosity processing, high glass transition temperatures, excellent electrical/mechanical/thermal properties, and hydrolysis resistant chemistries. These materials can be formulated for material to be used at temperatures up to 300 deg C. (572 deg F.).

While one or more of such resin chemistries may be inherently less effective for standard methods of covalent bonding to common stator elastomers, the use of one or more extruder generated surface roughness techniques may allow for one or more of these materials to be employed, which improved adhesion. Such an approach can generate enhanced composite PCP stators for high-temperature applications.

As explained, use of a tie layer may provide a partial solution where some covalent bonding happens and where the tie layer does not support forces being applied to the bonded layers. In such cases, a process may include utilizing surface roughness generated by reforming the surface of the polymer once melt processed as a means of mechanical anchoring along with the covalent bonding between the two dissimilar materials to elevate the robustness of the bonding. By applying such a technique, a tie layer scheme for bonding layers can be improved, which may result in manufacture of stators suitable for use in low flow ESPCP applications.

As an example, a method can achieve enhanced bonding through a modified tie layer with increased surface roughness generated by reforming the surface of the polymer once melt processed. For example, consider a method that includes manipulating an extrusion process to form rough surface features conducive for mechanical anchoring to generate superior bonding of dissimilar materials.

The geometry of a PCP rotor makes it inherently a source of elastomer inconsistencies. Its shape profile describes an eccentric displacement that results in large uneven sections of elastomeric material, which may be the primary source for failure down hole. As explained, a composite stator construction can help to reduce degradation mechanisms in an elastomer by a construction designed to mitigate several failure modes.

As an example, a method can include an extrusion process that can manipulate surface roughness of an elastomer during vulcanization to create a rough surface with increased surface area for additional bonding and mechanical anchoring. For example, consider a method that can include one or more of mechanical anchoring and increased covalent bonding functionality sites. As to mechanical anchoring, it may be achieved by a thermoset filling surface cavities and curing in the valleys of a rough topography in the tie layer. As an example, once a thermoset has solidified, rigidity of the thermoset can lock a tie layer into a composite. As a result, failure of the bonding would demand the tie layer to fail cohesively; however, a delamination in an adhesive fashion would not be possible due to the physical entrapment of the elastomer by the thermoset. As explained, surface roughness can create additional support in a bond by increasing surface area available for bonding. For elastomer and thermoset configurations where the base layers are relatively inert and functionally reactive sites are limited, expanding the surface area can allow for additional covalent bonding to again assist is improving the bonding ability of the tie layer material.

As an example, surface roughness may be generated by reforming the surface of a polymer once melt processed, where surface roughness may be created in one or more of various ways, including, but not limited, textured fabrics or patterned preforms. As an example, after melt processing, the surface of the elastomer tends to be soft and readily malleable. As a result, the surface can be manipulated by imprinting with a textured tape/fabric such as glass fabric or a patterned preform imbedded in the surface of the elastomer and maintaining the fabric/preform through vulcanization. In such an example, imprinting of the polymer surface can be achieved prior to vulcanization and can be “locked-in” during a vulcanization process such that the removal of the fabric/preform material leaves a permanent texture in the surface.

As an example, a method can provide for surface roughness generation by reforming the surface of a polymer once melt processed for improving the bonding of high performance elastomers and thermosets, which may be quite dissimilar and where blending functionality in a tie layer may offer an amount of covalent bonding functionality that may benefit from an additional mechanism for enhanced bonding. As mentioned, elastomers may include one or more of FKMs and FFKMs; noting that one or more other elastomers may be used, additionally or alternatively.

As an example, various resin chemistries may be inherently less effective for standard methods of covalent bonding to common stator elastomers. In such scenarios, use of surface roughness generated by reforming the surface of a polymer, once melt processed, may allow for such materials to be successfully employed, maximizing adhesion. Such an approach can provide for composite PCP suitable for various high-temperature applications.

As an example, a method can include utilizing surface roughness generated by scoring a polymer surface after vulcanization as a means of mechanical anchoring along with the covalent bonding between the two dissimilar materials to elevate the robustness of the bonding. In such an example, a tie layer scheme for bonding layers in the low flow ESPCP can be utilized to produce an effective tie layer for materials that may not be traditionally capable of being tied together.

As an example, a method can achieve enhanced bonding through a modified tie layer with increased surface roughness generated by scoring a polymer surface after vulcanization. In such an example, the method may include manipulating an extrusion process to form rough surface features conducive for mechanical anchoring to generate superior bonding of dissimilar materials.

As explained, a divergence of some of potential elastomer and thermoset compounds may benefit from an additional bonding mechanism to enhance and/or supplement covalent bonding of the elastomer and thermoset such that bonding may occur via one or more mechanisms.

As an example, a method can use an extrusion process to manipulate surface roughness of an elastomer post vulcanization to create a rough surface with increased surface area for additional bonding and mechanical anchoring. Such a method can be performed in one or more manners. For example, consider a technique that can provide for mechanical anchoring and increased covalent bonding functionality sites. As explained, mechanical anchoring may be achieved by a thermoset filling surface cavities and curing in valleys of a rough topography in a tie layer. In such an example, once the thermoset has solidified, rigidity of the thermoset can lock the tie layer into the composite. As a result, failure of the bonding would demand that the tie layer to fail cohesively. However, a delamination in an adhesive fashion may not be possible due to physical entrapment of the elastomer by the thermoset. As explained, surface roughness can create additional support in a bond by increasing surface area available for bonding. For elastomer and thermoset configurations where the base layers are relatively inert and functionally reactive sites are limited, expanding the surface area can allow for additional covalent bonding to again assist is improving the bonding ability of the tie layer material.

As explained, surface roughness may be generated in one or more manners. For example, consider scoring a polymer surface after vulcanization using one or more of cutting rollers, grinding wheels, plug cutters, lasers, milling bits, and heated knives. After vulcanization the surface of the elastomer tends to be “locked-in” to a final shape and as a result, a viable way to change surface roughness at this point is by removal of material from surface and/or by cutting grooves into the elastomer.

As an example, a method may utilize a series of cutting rollers that can score the surface of an elastomer to generate tiny anchor points for thermoset materials. In such an example, rather than just cutting small knife marks in the elastomer, material may optionally be removed by plugging, milling, or using a hot knife to remove small sections of material to create valley anchor points for bonding. As explained, one or more lasers may be utilized, which may provide for thermal effects, ablation, etc. As an example, another option for elastomer removal can be to roughen the surface with abrasives. For example, a grinding process may be utilized to tailor the surface roughness in a manner akin to sanding a wooden or metal part with various grit sandpaper give relative smoothness/roughness after application. As an example, one or more non-contact types of methods may be employed for imparting surface roughness. For example, laser etching or gas and/or water jetting (e.g., contact with gas and/or water) may be considered non-contact techniques that can be used to cut various small grooves into an elastomer, for example, to act as anchor points for enhanced bonding to a thermoset.

As an example, surface roughness may be generated post vulcanization to improve bonding of high-performance elastomers and thermosets that may be quite dissimilar where blending functionality in a tie layer may an amount of covalent bonding functionality that can be supplemented and/or improved through surface roughness.

As mentioned, elastomers may be selected from various types of elastomers. For example, consider one or more of FKMs and FFKMs; noting that other types of elastomers may be utilized, additionally or alternatively.

As explained, common thermosetting chemistries for bonding applications tend to be based on either polyester, epoxy, benzoxazine, polyimide, bismaleimide, or cyanate ester chemistry. While robust in many uphole applications, these thermosets tend to be limited in chemical compatibility and high-temperature capability. For example, with high-temperature exposure with small amounts of water, such polymers can be susceptible to hydrolysis. Hydrolysis causes a reduction in glass transition temperature and weakening of the polymer from a mechanical perspective.

Additionally, for applications where the temperature is above 175-200 deg C., the detrimental effect can be much greater.

As an example, one or more types of resin chemistries for encapsulation may be utilized. Such resin chemistries can offer low viscosity processing, high glass transition temperatures, excellent electrical/mechanical/thermal properties, and hydrolysis resistant chemistries. These materials can be formulated for material to be used at temperatures up to 300 deg C. (572 deg F.).

While one or more of such resin chemistries may be inherently less effective for standard methods of covalent bonding to common stator elastomers, the use of one or more extruder generated surface roughness techniques may allow for one or more of these materials to be employed, which improved adhesion. Such an approach can generate enhanced composite PCP stators for high-temperature applications. As explained, one or more techniques may be utilized to form stators suitable for ESPCP applications.

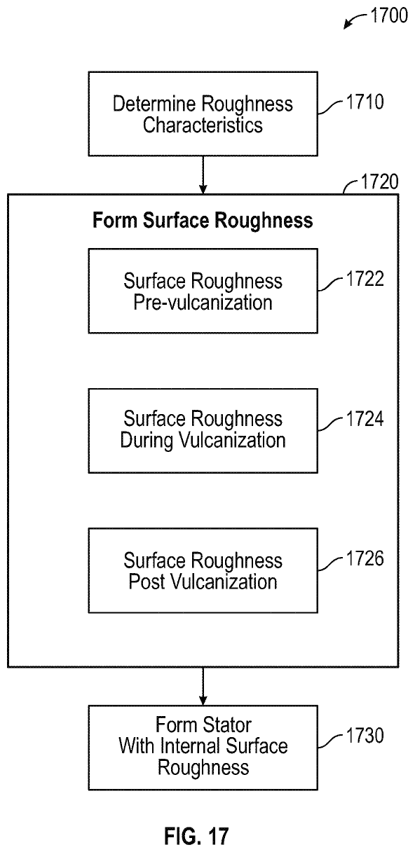

FIG. 17 shows an example of a method 1700 that includes a determination block 1710 for determining surface roughness characteristics, a formation block 1720 for forming surface roughness, and a formation block 1730 for forming a stator with internal surface roughness at an interface between two layers. As shown, the block 1720 can include various options such as imparting surface roughness pre-vulcanization 1722, during vulcanization 1724 and/or post vulcanization 1726.

A fluid displacement pump can include a rotor; and a stator, where the stator includes two materials bonded by a tie-layer material and where the tie-layer is formed with surface roughness. In such an example, the two materials can include a thermoset and an elastomer.

As an example, a tie-layer can be or include an extruded tie-layer. For example, consider use of an extruder that can receive material and extrude the material (e.g., via a die, etc.) onto a surface.

As an example, surface roughness of a tie-layer may be imparted pre-vulcanization, during vulcanization and/or post vulcanization.

As an example, surface roughness can include ridges and valleys. As an example, surface roughness can include features having a length scale greater than 0.01 mm, features having a length scale greater than 0.1 mm, features having a length scale greater than 0.5 mm, and/or features having a length scale greater than 1 mm.

As an example, surface roughness can be in the form of a pattern. For example, consider using one or more techniques that can impart a pattern. For example, consider a tool that can impart a pattern via contact, a beam that can impart a pattern via interaction of the beam and a material, a fluid jet that can impart a pattern via interaction of the fluid jet and a material, etc.

As an example, a method can include forming surface roughness in tie-layer of a stator; depositing material on the tie-layer; and forming a stator, where the stator includes two materials bonded by the tie-layer material. In such an example, the method may include forming the surface roughness pre-vulcanization of the tie-layer, during vulcanization of the tie-layer and/or post vulcanization of the tie-layer.

As an example, a method can include forming surface roughness that includes peaks and valleys and a pattern or patterns.

As an example, a method can include forming surface roughness in a tie-layer in a manner that provides for increasing a surface area of the tie-layer.

As an example, a method can include forming surface roughness in a tie-layer by generating an uneven thickness of the tie-layer.

As an example, a method can include extruding a tie-layer. In such an example, an extruder may include one or more features for imparting desired surface roughness in the tie-layer.

As an example, a method can include forming a fluid displacement pump using a stator that includes a tie-layer with surface roughness.

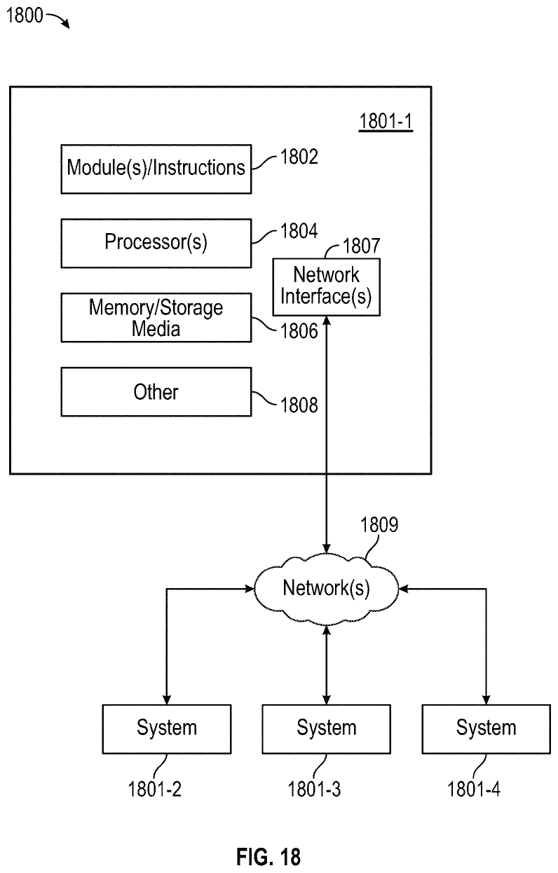

In some embodiments, the methods of the present disclosure may be executed by a computing system. FIG. 18 illustrates an example of such a computing system 1800, in accordance with some embodiments. The computing system 1800 may include a computer or computer system 1801-1, which may be an individual computer system 1801-1 or an arrangement of distributed computer systems such as systems 1801-2, 1801-3 and 1801-4. The computer system 1801-1 includes instructions 1802 that are configured to perform various tasks according to some embodiments, such as one or more methods disclosed herein. To perform these various tasks, the instructions 1802 can execute independently, or in coordination with, one or more processors 1804, which is (or are) connected to one or more storage media 1806. The processor(s) 1804 is (or are) also connected to a network interface 1807 to allow the computer system 1801-1 to communicate over a data network 1809 with one or more additional computer systems and/or computing systems, such as 1801-2, 1801-3, and/or 1801-4 (note that computer systems 1801-2, 1801-3 and/or 1801-4 may or may not share the same architecture as computer system 1801-1, and may be located in different physical locations, e.g., computer systems 1801-1 and 1801-2 may be located in a processing facility, while in communication with one or more computer systems such as 1801-3 and/or 1801-4 that are located in one or more data centers, and/or located in varying countries on different continents). As shown, one or more additional components 1808 may be included.

A processor may include a microprocessor, microcontroller, processor module or subsystem, programmable integrated circuit, programmable gate array, or another control or computing device.

The storage media 1806 may be implemented as one or more computer-readable or machine-readable storage media. Note that while in the example embodiment of FIG. 18 storage media 1806 is depicted as within computer system 1801-1, in some embodiments, storage media 1806 may be distributed within and/or across multiple internal and/or external enclosures of computing system 1801-1 and/or additional computing systems. Storage media 1806 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, etc.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

1. A fluid displacement pump comprising:
a rotor; and
a stator, wherein the stator comprises two materials bonded by a tie-layer material and wherein the tie-layer is formed with surface roughness.

2. The fluid displacement pump of claim 1, wherein the two materials comprise a thermoset and an elastomer.

3. The fluid displacement pump of claim 1, wherein the tie-layer comprises an extruded tie-layer.

4. The fluid displacement pump of claim 1, wherein the surface roughness is imparted pre-vulcanization, during vulcanization and/or post vulcanization.

5. The fluid displacement pump of claim 1, wherein the surface roughness comprises ridges and valleys.

6. The fluid displacement pump of claim 1, wherein the surface roughness comprises features having a length scale greater than 0.01 mm.

7. The fluid displacement pump of claim 1, wherein the surface roughness comprises features having a length scale greater than 0.1 mm.

8. The fluid displacement pump of claim 1, wherein the surface roughness comprises features having a length scale greater than 0.5 mm.

9. The fluid displacement pump of claim 1, wherein the surface roughness comprises features having a length scale greater than 1 mm.

10. The fluid displacement pump of claim 1, wherein the surface roughness comprises a pattern.

11. A method comprising:
forming surface roughness in a tie-layer of a stator;
depositing material on the tie-layer; and
forming a stator, wherein the stator comprises two materials bonded by the tie-layer material.

12. The method of claim 11, wherein the forming surface roughness comprises forming pre-vulcanization of the tie-layer.

13. The method of claim 11, wherein the forming surface roughness comprises forming during vulcanization of the tie-layer.

14. The method of claim 11, wherein the forming surface roughness comprises forming post vulcanization of the tie-layer.

15. The method of claim 11, wherein the surface roughness comprises peaks and valleys.

16. The method of claim 11, wherein the surface roughness comprises a pattern.

17. The method of claim 11, wherein the forming surface roughness comprises increasing a surface area of the tie-layer.

18. The method of claim 11, wherein the forming surface roughness comprises generating an uneven thickness of the tie-layer.

19. The method of claim 11, comprising extruding the tie-layer.

20. The method of claim 11, comprising forming a fluid displacement pump using the stator.
